(19) United States
(12) Patent Application Publication
(10) Pub. No.: US 2006/0217942 A1
(43) Pub. Date: Sep. 28, 2006

(54) Method for recognizing connectable surfaces

(75) Inventor: Martin Daferner, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Daimler Chrysler AG, Stuttgart (DE)

(21) Appl. No.: 10/559,517

(22) PCT Filed: May 28, 2004
(86) PCT No.: PCT/EP04/05777

§ 371 Date: Apr. 7, 2006

(30) Foreign Application Priority Data
Jun. 11, 2003 (DE) 10326282.8

(51) Int. Cl. G06F 17/10

(52) U.S. Cl. 703/2

(57) ABSTRACT

A method for automatically detecting connectable surfaces in a technical system. The system includes bodies that can be connected to one another in pairs by applying a joining technology. A computerized design model of the system that, for each body of the system, includes at least one surface belonging to the body, and a joining technology, for example a specific bonding method, are provided. The joining technology produces a layer between in each case two bodies of the system. The surfaces or sub-areas of surfaces of the system that can be connected by the prescribed joining technology are automatically detected. For this purpose, those interspaces between in each case two surfaces of the design model that can be filled with a layer produced by the joining technology are automatically detected. Pairs of connectable finite elements are determined thereby. A computer evaluable decision criterion that compares the positions and/or orientations of the two finite elements with prescribed upper and/or lower bounds is applied for the determination.

The invention relates to a method for automatically detecting connectable surfaces in a technical system. The system comprises bodies. These bodies can be connected to one another in pairs by applying a joining technology.

An important joining technology is the production of bonded joints. These are increasingly being applied in automobile construction, for example, because it is technically impossible to produce a welded connection, the surfaces to be connected are difficult to access by the welding operator or automatic welding machine, or because the welded connection cannot withstand the loads and forces occurring. A welded connection is often impossible or uneconomic in particular, whenever the two bodies are produced from different materials, for example, aluminum and steel or aluminum and magnesium, or when at least one of the boundary surfaces of the body consists of plastic.

The term “joint” also includes below seals between two bodies that have, for example, the task of ensuring a minimum spacing between two bodies, and in this case exhibit specific elastic properties or effect noise damping or insulation.

A computerized design model of the system is prescribed that, for each body of the system, comprises at least one surface belonging to the body.

The connectable surfaces and the layers between the connectable surfaces are preferably decomposed into finite elements. Finite element simulations are subsequently carried out. The mechanical behavior of the system is predicted by evaluating the simulation results.

The method of finite elements is known from “Dubbel—Taschenbuch für den Maschinenbau”, [Dubbel-Manual of mechanical engineering], 20th edition, Springer-Verlag, 2001, C 48 to C 50, and also from T. R. Chandrupalta & A. D. Belegundu: “Introduction to Finite Elements in Engineering”, Prentice-Hall, 1991. Strength problems of all types, for example relating to stress distribution or stability, are solved numerically by simulation with the aid of finite elements. For example, it is determined how a system composed of a number of solid bodies is deformed and bent under external loads, and how the bodies are displaced relative to one another. A computerized design model of a system to be investigated is given. A specific set of points that are called nodal points are fixed in this design model. The surface or volume elements that are formed with the aid of the nodal points as their corners are denoted as finite elements. Curved surfaces or bodies that are treated approximately as surfaces, for example panels of a motor vehicle bodywork, are often decomposed thereby into shell elements. The nodal points form a network in the design model, for which reason the process of fixing nodal points and generating finite elements is termed meshing of the design model. Depending on the object set, displacements of these nodal points and/or rotations of the finite elements at these nodal points or the stresses in these finite elements are introduced as unknowns. Equations are set up that approximately describe the displacements, rotations or stresses inside a finite element. Further equations result from dependencies between various finite elements, for example because the principle of virtual work at the nodal points must be followed, and the calculated displacements must be continuous and must satisfy the boundary condition that gaps or instances of penetration do not occur in reality.

In many cases, such equations are linear in the unknowns. The method of finite elements can, however, likewise be applied in the case of nonlinear equations, for example for equations in the form of polynomials. Altogether, an often very extensive system of equations with the nodal point displacements, nodal point rotations, element stresses or other variables as unknowns is set up and solved numerically. The solution describes, for example the deformation state of the system under prescribed loads. Stress distributions, vibration behavior, buckling behavior or prediction of lifetime, for example, can be derived from this mechanical solution. If, for example, displacements and rotations of all the nodal points of a finite element are determined, the stress in the element can thus be derived.

Various bodies of a system are often meshed independently of one another. For example, the system is part of the bodywork of a motor vehicle to be designed, and the bodies are part systems that are designed in time-parallel fashion by various suppliers without the meshings being adapted to one another. Because the bodies are meshed independently of one another, the nodal points on mutually adjoining surfaces of the bodies often do not lie on one another but are, for example, displaced relative to one another, or belong to finite elements of different sizes and different orientations in space. Such meshings of mutually adjoining bodies are denoted as incompatible meshings.

A realistic finite element simulation must take account of the interactions and functional dependencies between the bodies that are caused by the mutually adjoining surfaces. What is desired are finite element simulations that take account of these interactions and functional dependencies even in the case of independent, and therefore generally incompatible, meshings of the bodies. The point is that if a compatible meshing were necessary for setting up the system of equations and carrying out the simulations, the bodies cannot be meshed independently of one another.

U.S. Pat. No. 5,560,570 B1 discloses a method for meshing a system with a number of bodies in accordance with the finite element method. A computerized design model is respectively prescribed for each body. Each body comprises at least one surface belonging to the body. The two bodies are firstly meshed independently of one another. The meshing of one body is changed in such a way that it matches the meshing of the other body.

U.S. Pat. No. 6,343,385 describes a method for determining a trajectory on which a rigid body is introduced into a cavity without collision. Both the rigid body and the cavity are meshed in accordance with the finite element method.

G. Tokar: “Punktschweiβkleber—Eigenschaften und Berechnungsmethode für lineare Karosseriesteifigkeiten”, [“Spot weld adhesives—properties and calculation methods for linear rigidity of the bodywork”] VDI-Berichte [Reports] No. 1559, pages 549-575, 2000 discloses a method for finite element simulation of a bonded joint. Finite element simulations are carried out for a system that comprises two sheets that are connected by a bonded seam. Because of external loads, displacements occur between and inside the sheets that are predicted by the simulations. Finite elements are generated for the simulations in the sheets and in the connecting bonding layer.

The method disclosed in G. Tokar, loc. cit, requires a great deal of manual work in the case when the system to be investigated includes many bodies with connectable surfaces or surfaces with complicated geometry. This is the case, for example, whenever the body is a motor vehicle to be designed. An operative must mark the bonded seams manually in a design model of the system.

It is the object of the invention to provide a method by means of which it is detected automatically whether a number of surfaces of various bodies of a technical system can be connected to one another by a prescribed joining technology. A computerized design model system is prescribed that, for each body of the system, comprises at least one surface belonging to the body.

The object is achieved by means of a method as claimed in claim 1. Advantageous refinements are specified in the subclaims.

In accordance with the method according to the invention as claimed in claim 1, the computerized design model of the system comprises a number of surfaces. Each of these surfaces belongs to a body of the system. For example, the surfaces are surfaces of the bodies or surfaces that approximate the respective bodies. In the case of thin sheets as bodies, the approximating surfaces are preferably their middle surfaces. The design model does not necessarily comprise volumetric models of the bodies.

A joining technology, for example, a specific bonding method, is prescribed. The joining technology produces a layer between in each case two bodies, for example a bonded seam or a seal. Finite elements are generated for the surfaces. According to the invention, those surfaces or sub-areas of surfaces of the system that can be connected by the prescribed joining technology are automatically detected. For this purpose, those interspaces between in each case two surfaces of the design model that can be filled with a layer produced by the joining technology are automatically detected. For example, those interspaces between two surfaces each that can be filled by a bonded seam upon application of the bonding method are detected.

All the surface pairs that consist in each case of two different surfaces of the design model are determined during the detection of the interspaces. Subsequently, connectable pairs of finite elements in these surface pairs are automatically determined. The method steps described below are carried out for each surface pair, which consists of two surfaces of different bodies. The surfaces of such a surface pair are candidates for being connected fully or in sub-areas with the aid of a prescribed joining technology. All the element pairs of a surface pair having the following properties are selected:
The element pair consists of in each case one finite element of one surface, and of one finite element of the other surface of the surface pair.
The two finite elements of the element pair have a spacing from one another that is smaller than or equal to a prescribed upper bound.

An element pair that consists of two finite elements of the same surface is not selected. An element pair that consists of two finite elements whose spacing from one another is greater than the prescribed bound is likewise not selected. If, for example, the system comprises three bodies and the design model of each body in each case comprises four surfaces, and if each of these surfaces is decomposed into 100 finite elements, there are thus 4*3/2=6 surface pairs and 100*100 element pairs per surface pair. If each finite element of one surface has a spacing of smaller than or equal to the upper bound relative to four finite elements of the other surface, 100*4 element pairs are selected per surface pair.

This selection is carried out such that all the pairs of connectable finite elements are located among the selected pairs, that is to say all the pairs not selected are not connectable. A computerized selection rule that can be carried out quickly is applied to the selection. The selected pairs of finite elements are thoroughly investigated. It is thereby decided for each selected element pair whether the two finite elements of the element pair can be connected by the joining technology or not. To take the decision automatically, a decision criterion that can be evaluated by computer is applied to compare the positions and/or orientations of the two finite elements with prescribed upper and/or lower bounds. These bounds are preferably provided as a function of technical properties of the joining technology. For example, in the case of the bonding method a bonded seam may be at most 1 mm thick and must be at least 0.2 mm.

The invention takes account, without additional method steps, of the possibility that only parts of two surfaces can be connected to one another by the joining technology, whereas other parts cannot be. For example, one body is a flat sheet and another body is a V-shaped folded sheet. One area of the flat sheet can be connected to one limb of the folded sheet, but not to the other one. The two sheets are approximated by their middle planes. Connectable finite elements of surfaces are determined in accordance with the method according to the invention. In this case, it is exclusively finite elements in the one connectable limb of the V-shaped sheet that are determined.

Because the tests for connectability are applied to finite elements of surfaces, there are fewer comparative operations to be carried out than if the tests were to be applied to finite elements in bodies. Specifically, finite elements in surfaces are generally described by fewer parameters. The advantage of managing with fewer comparative operations is chiefly important when thousands or even hundreds of thousands of finite elements are generated for the surfaces, something which can be the case, for example, with design models having many surfaces or in the case of a fine decomposition of the surfaces into many small finite elements.

A computerized design model of the system with surfaces for the bodies is prescribed for carrying out the method according to the invention. There is no need for the design model to include volumetric models of the bodies. Consequently, the method can already be applied at an early stage in the product development process, specifically at a point in time when only the boundary surfaces or approximating surfaces of the bodies, but as yet no details of the bodies, are fixed. The use of surfaces and of finite elements in the form of surface elements also effects a considerable saving in computing time as well as in arithmetic capability and memory capacity by comparison with the use of volumetric models and volume elements as finite elements.

Because the pairs of connectable finite elements and therefore connectable surfaces are determined automatically, it is impossible for those errors to occur that an operative, for example a computing engineer, can commit when manually fixing connectable surfaces. Precisely in the case of an extensive system, for example a motor vehicle, many pairs of surfaces come into consideration for being connected by the prescribed joining technology. The manual stipulation of the pairs that can actually be connected is a time-consuming and error-prone routine operation and, in some cases cannot be executed at all in an acceptable time.

The decision criterion that is applied in accordance with claim 1 to determine connectable element pairs is a computerized, automatically evaluable criterion. It supplies the connectable surfaces or areas of surfaces substantially more quickly than an operative by manual stipulation. Consequently, the determination of connectable surfaces is objective and practicable and can be repeated as often as desired. There is no need to keep asking experienced designers or computing engineers for expert knowledge with each application. Subjective factors and errors or mistakes that frequently occur in the case of manual stipulation are excluded. There is, furthermore, no need to prescribe a stipulation as to which surfaces are to be neighboring or overlapping.

The method according to the invention can also be applied whenever the system comprises many bodies with connectable surfaces or surfaces of complicated geometry. For such a system it is often impossible to determine interspaces between connectable surfaces by hand in an acceptable time.

The advantage of automatic detection is still more important whenever the prediction of the mechanical behavior must be carried out several times. This is necessary, for example whenever various design models of a technical system are to be compared, or various design states are run through during designing and, in the process, the positions and/or orientations of surfaces are varied. The generation of finite elements is a renewed necessity for each finite element simulation of a design model or of a design state.

It is possible to determine automatically by means of the method according to the invention pairs of connectable surfaces that have not been found by operatives as applications of the prescribed joining technology. This is the case whenever finite elements in the surfaces fulfill the decision criterion and are determined as being connectable. If, for example, the joining technology that is prescribed for the method according to the invention is more cost-effective than other joining technologies, the method according to the invention exhibits possibilities for savings. For example, bonding is prescribed as joining technology and makes it possible to design individual bodies in plastic instead of in steel. It is only by bonding that bodies made from plastic can be connected to one another.

The method according to the invention can also be applied whenever surfaces of the design model have been meshed independently of one another and therefore have incompatible meshings. Because the meshings were carried out independently and can be incompatible, the bodies of the system can be designed in parallel, for example by different operatives who need not synchronize their work for meshing. Because parallel design and parallel meshing is rendered possible, and there is no need to coordinate meshings, time is spared and simultaneous product design is enabled. It is possible to mesh the surfaces independently of one another and firstly to carry out finite element simulations for each body independently of other bodies. Once the meshings of the individual surfaces have been produced, they can be reused for a different finite element simulation of the entire system.

The selected element pairs detected as connectable delimit interspaces between surfaces or sub-areas of surfaces of the design model. Further finite elements are preferably generated for these interspaces. In this refinement, the method according to the invention additionally facilitates and speeds up the meshing of the connecting layer. The nodal points of these further finite elements can be used to set up equations for the mechanical behavior of the layers in the interspaces, and for mechanical dependencies between the layers and the adjoining surfaces.

The mechanical behavior of a layer can be predicted realistically only when the layer occurs as a spatial, that is to say three-dimensional, object, and not as a surface in the simulation. Further finite elements are therefore preferably generated for the layer. In accordance with claim 12, the interspaces between the pairs of finite elements determined in accordance with the invention are automatically meshed. Finite elements with nodal points are thereby generated for these interspaces. This meshing need not necessarily depend on the meshing of the approximating surfaces. Consequently, the meshing of the layers can be effectively adapted to the respective tasks that are to be treated with the aid of the solution of the system of equations generated according to the invention. For example, depending on the tasks, the connecting layer is decomposed into many small or a few large further finite elements. The thickness of the connecting layer is taken into account even when the layer has different thicknesses at various points. The layer is treated in the system of equations by using continuum mechanics. For example, one body is a flat sheet, and another body is a V-shaped folded sheet. In accordance with the method according to the invention it is exclusively finite elements in one connectable limb of the V-shaped sheet, and finite elements in the adjoining part of the other sheet that are determined as connectable finite elements. Further finite elements are generated only in the interspace between the connectable limb and the opposite area of the flat sheet.

Mechanical parameters of the layer can also be taken into account in equations of the system of equations. If the layer is a bonded seam, for example, mechanical parameters of the adhesive used can be taken into account. The mechanical behavior of the connecting layer in the event of displacements of the respective surfaces parallel to the layer can be predicted.

Claim 2 establishes refinements as to how the selection of element pairs is carried out quickly on the basis of their spacing. The selection that can be executed quickly is made according to claim 2 with the aid of the nodal points of the two surfaces of a surface pair. Firstly, all the node pairs are determined that consist in each case of one nodal point of one surface and one nodal point of the other surface. If one surface comprises N_{—}1 nodal points, and the other surface comprises N_{—}2 nodal points, N_{—}1*N_{—}2 nodal pairs are determined thereby. The spacing between the two nodal points of the node pair is determined for each node pair. A selection is made from among the N_{—}1*N_{—}2 pairs of nodal points. Those node pairs whose two nodal points have a spacing that is smaller than or equal to a prescribed upper bound are selected.

It is possible to determine all the element pairs that respectively consist of a finite element of one surface, and a finite element of the other surface, of the surface pair. Very many element pairs are often determined thereby. Instead of this claim 2 envisages a preselection: each element pair of which one finite element has one nodal point of a selected node pair as a nodal point, and whose other finite element has the other nodal point of the pair as a nodal point is determined and thereby selected. Further calculations are carried out only for these element pairs determined in such a way and thus selected. Those element pairs that have not been selected in accordance with the mode of procedure just described are classified as non-connectable. These further calculations require calculations that take up more time, as a rule. By contrast, the preselection on the basis of the spacings of nodal points can be carried out quickly because spacings of nodal points can be calculated quickly. For example, the spacing is determined only between selected element pairs, and the element pairs with not too large a spacing are selected from among the determined element pairs.

Claim 3 and claim 4 develop the refinement according to claim 2. An additional preselection from among the determined element pairs is carried out on the basis of the spacings of nodal points.

In accordance with claim 3, a check is made for each determined element pair as to whether each nodal point of one finite element of the element pair has a spacing from at least one nodal point of the other finite element that is smaller than or equal to a prescribed upper bound. If a nodal point of one finite element has too large a spacing from all the nodal points of the other finite element, the test is terminated and the element pair is not preselected and therefore not selected and subjected to further tests. Those previously determined element pairs are preselected for which the test supplies a positive result.

By contrast, in accordance with claim 4, a test is made for each determined element pair as to whether each nodal point of one finite element of the element pair has a spacing from all the nodal points of the other finite element that is smaller than or equal to a prescribed upper bound. If a nodal point of one finite element has too large a spacing from a nodal point of the other finite element, the test is terminated and the element pair is not preselected and therefore not selected and subjected to further tests. Those previously determined element pairs are preselected for which the test supplies a positive result.

Claim 5 provides that the spacing between two finite elements of an element pair is compared not only with the upper bound, but also with a prescribed lower one. The element pair is not selected if the spacing is smaller than the lower bound. A selection from among the element pairs is thereby already carried out on the basis of the spacing. Whenever the spacing is greater than an upper bound or smaller than a lower one, it is decided that the finite elements are not connectable.

Claim 6 establishes refinements as to how the selection of element pairs is carried out quickly on the basis of their spacing. Approximations for the spacing are determined thereby with the aid of various sequences, and compared with upper and/or lower bounds. At least one of these sequences is preferably executed when determining spacing. It is also possible to carry out a number of sequences and to compare the respectively determined spacing with an upper and/or lower bound in each case. If all the sequences and comparisons lead to a positive result, further tests are carried out in order to decide that the two finite elements are connectable. If a comparison leads to a negative result at the end of a sequence, it is decided that the two finite elements are not connectable.

The refinement according to claim 7 lays down a range of further tests which feature in the decision criterion that can be evaluated by computer. At least one of these tests is carried out when taking the decision concerning whether the finite elements of a selected element pair are connectable or not. The decision criterion preferably applies a logical combination of the results of these tests. For example, finite elements of a pair are classified as connectable whenever all the tests, or whenever at least a single test are/is fulfilled. The individual tests are preferably carried out in a prescribed sequence such that the individual tests with the lowest computational outlay are carried out first. The carrying out of the individual tests is terminated for an element pair when it has already been established on the basis of the individual tests already carried out whether the finite elements of the pair are connectable or not.

At least one of the following individual tests is carried out in accordance with claim 7:
Do the finite elements belong to surfaces of different bodies? Specifically, it is possible that the two finite elements of an element pair belong to two different surfaces of the same body and are connectable.
The angle between the two finite elements of the element pair is determined, for example as an angle between two normals to the finite elements. A test is made as to whether the angle is smaller than or equal to an upper bound—the test then delivering a positive result—or not.
One finite element of the element pair is projected along a projection vector. This projection vector is generated, for example by generating two normals of the same length on the two finite elements, and the projection vector is the sum vector of these two (claim 8). It is tested whether the projected finite element overlaps the other finite element—the test then supplying a positive result—or not.
The midpoints of the two finite elements of the element pair are determined. One finite element of the element pair is projected along a projection vector. The spacing between the midpoint of the projected finite element and the midpoint of the other finite element is determined. A test is made as to whether this spacing is smaller than or equal to an upper bound—the test then supplying a positive result—or not.
As just described, the spacing between the midpoint of the projected finite element and the midpoint of the other finite element is determined. The length of the longest edge of the two finite elements of the pair is determined. The quotient of the spacing and the longest edge length is calculated. A test is made as to whether the quotient is smaller than or equal to an upper bound—the test then supplying a positive result—or not.

In accordance with claim 9, at least one bound depends on at least one of the following parameters:
a technical parameter of the prescribed joining technology,
the nature of a surface of a body,
the material provided for producing a body,
a stipulation valid for all the bodies of the system.

In the case of a bonded joint, the maximum and the minimum achievable thickness of the bonding layer, and the material used for bonding are two such technical parameters. The stipulation valid for all the bodies results, for example from esthetic stipulations or from company standards.

In accordance with claim 10, the term joining technology covers many possible technologies, for example bonding, welding or else that of a sealing or insulating or spacing layer. For example, a spacing layer made from rubber is inserted in order to observe a prescribed minimum spacing between various parts of the bodywork, for example planking and inner parts of a motor vehicle.

The refinement according to claim 11 takes into account the possibility of various joining technologies coming into consideration for connecting boundary surfaces. These various joining technologies respectively have an evaluation that depends, for example, on the costs and/or the reliability of the respective technology. For each pair of boundary surfaces, the joining technologies that can be applied for connecting this pair are determined. It is possible that not a single, or only one, joining technology is determined. If, by contrast, a number are determined, one is selected with the aid of the evaluations. It is possible for different joining technologies to be selected thereby for one system.

The mechanical behavior of the layer can then be predicted yet more realistically when the dependencies and interactions between a layer in one of the interspaces and the surfaces connected by the layer are taken into account. Mechanical dependencies exist between nodal points of further finite elements of the layer and adjoining points of a boundary surface of a body connected to the layer, for example the principle of virtual work, in accordance with which the forces and moments between the nodal points and the adjoining points are in equilibrium. These dependencies are taken into account by equations between the nodal points in the layer and adjoining points.
Claim 16 provides an advantageous refinement of how these dependencies are taken into account. Claim 17 exhibits a further refinement that spares nodal points and which thereby reduces the number of unknowns in the system of equations to be solved.

An exemplary embodiment of the invention is described below in more detail with the aid of the attached drawings, in which:

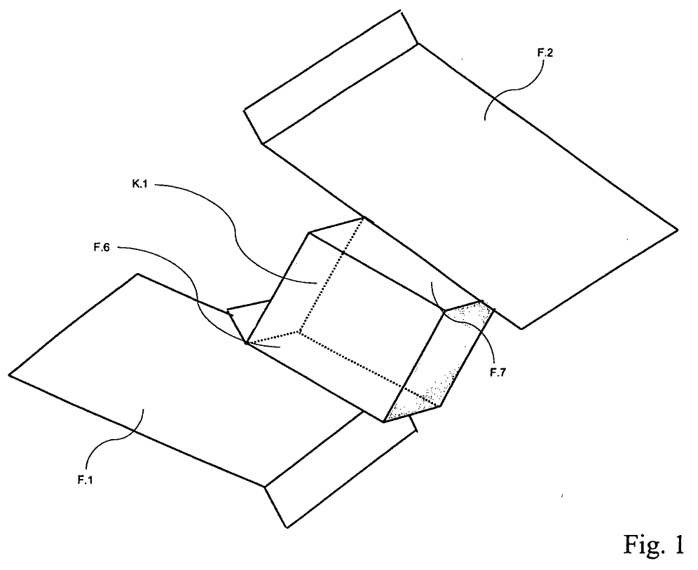

FIG. 1 shows a body and two approximating middle surfaces of the system to be investigated;

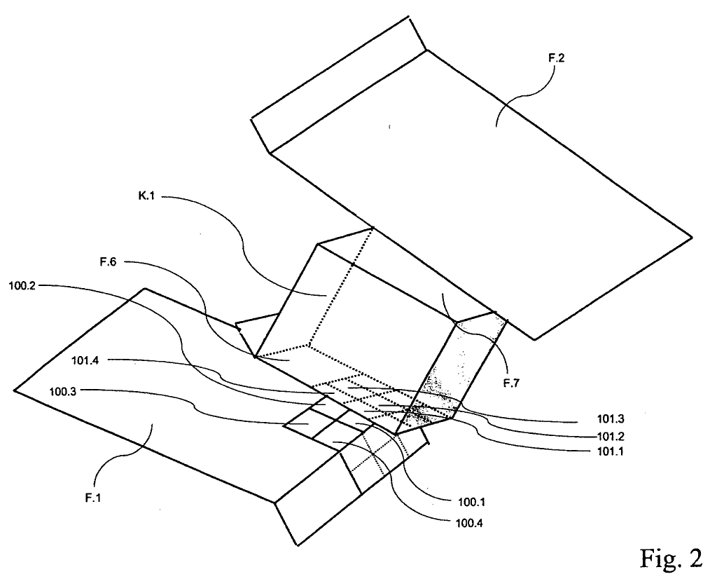

FIG. 2 shows surface elements for the body and middle surfaces of FIG. 1;

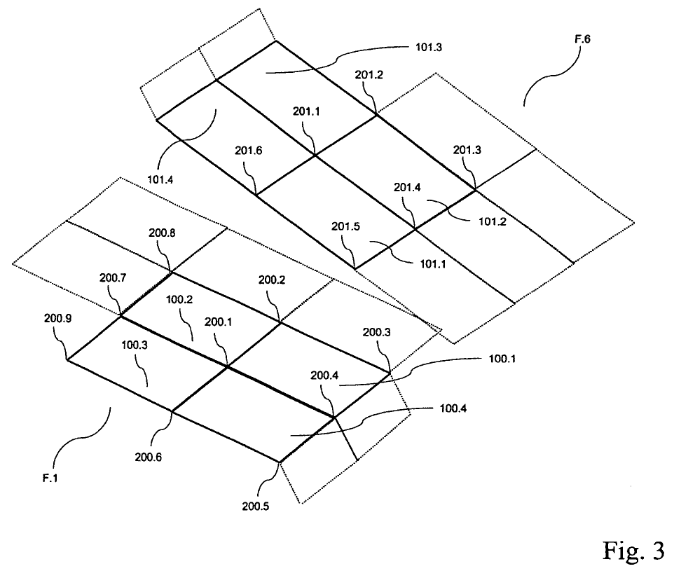

FIG. 3 shows the determination of the minimum and maximum spacing between two surface elements (first and second test);

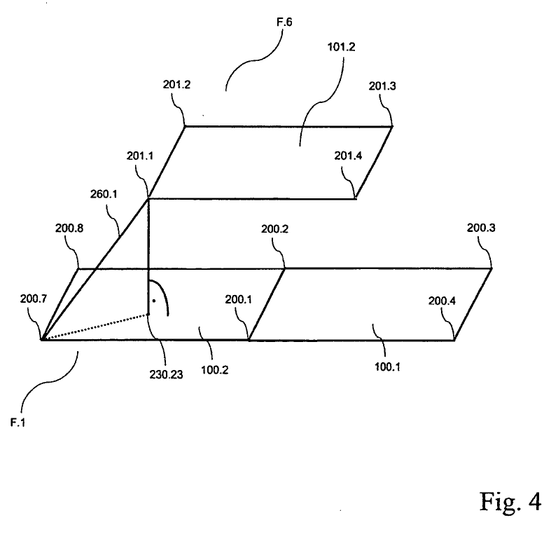

FIG. 4 shows the fixing of an upper bound for the spacing between two nodal points;

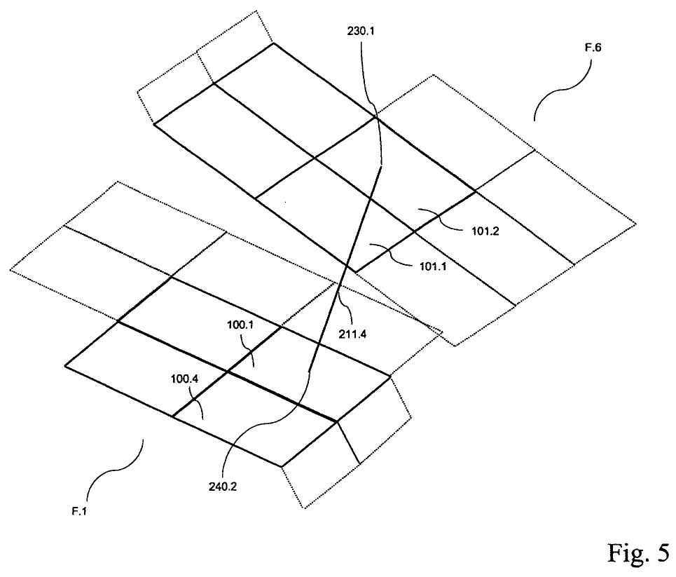

FIG. 5 shows the determination of the spacing between middle point and point of intersection of a normal (first test);

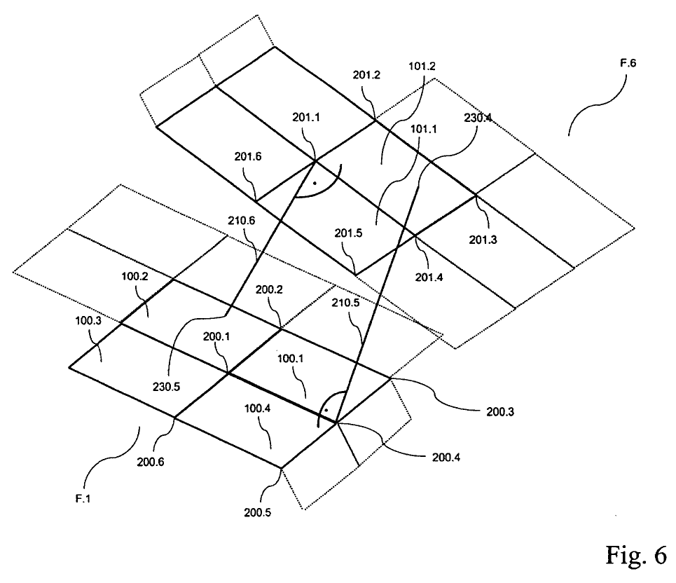

FIG. 6 shows the determination of the spacing between nodal point and point of intersection of a normal (second test);

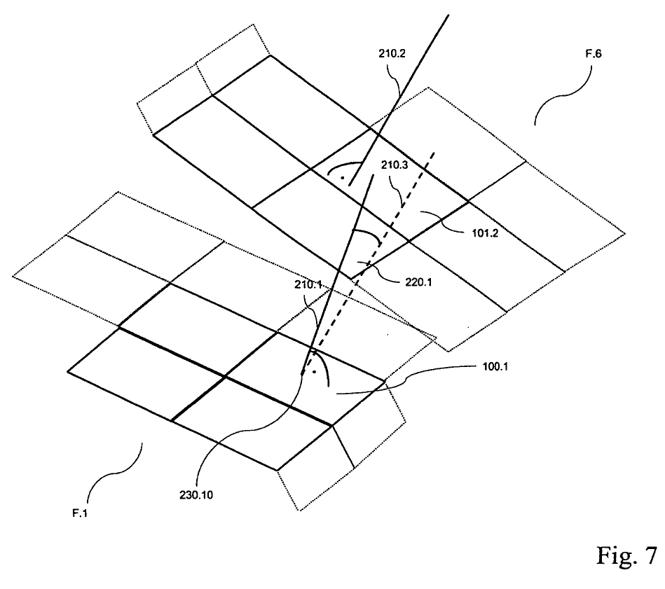

FIG. 7 shows the determination of the maximum angle between two surface elements (third test);

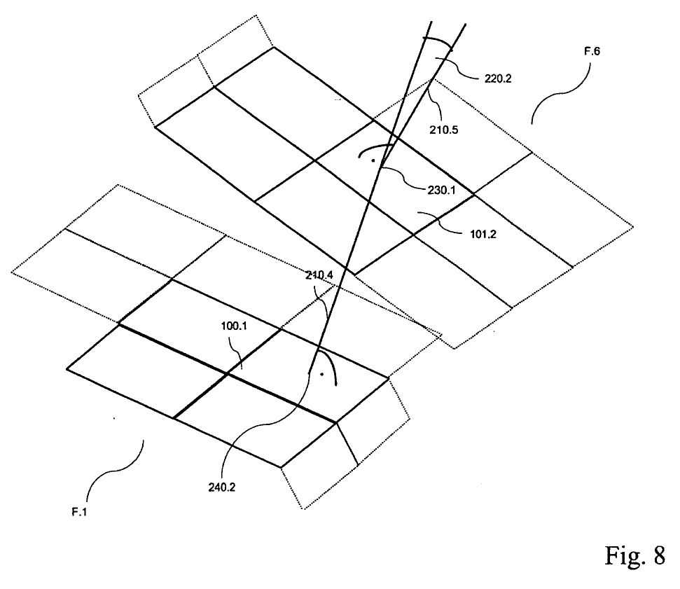

FIG. 8 shows the determination of the maximum angle between two surface elements in another embodiment (modification of the third test);

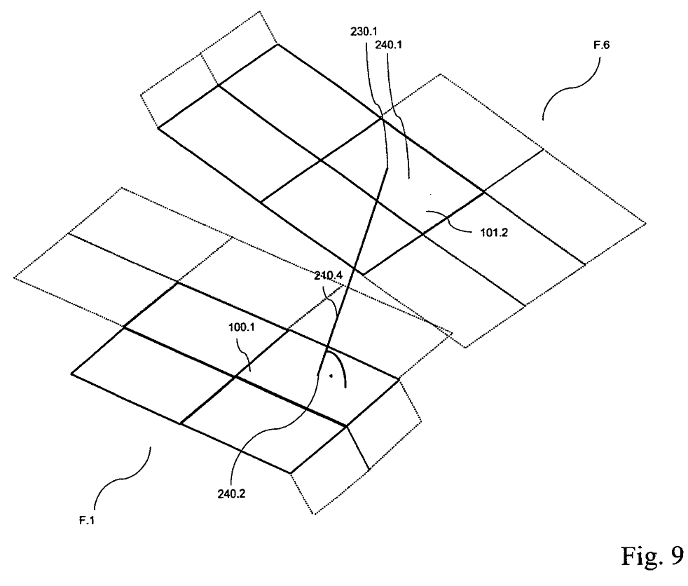

FIG. 9 shows the determination of the spacing between midpoint and point of intersection of a normal (fourth test);

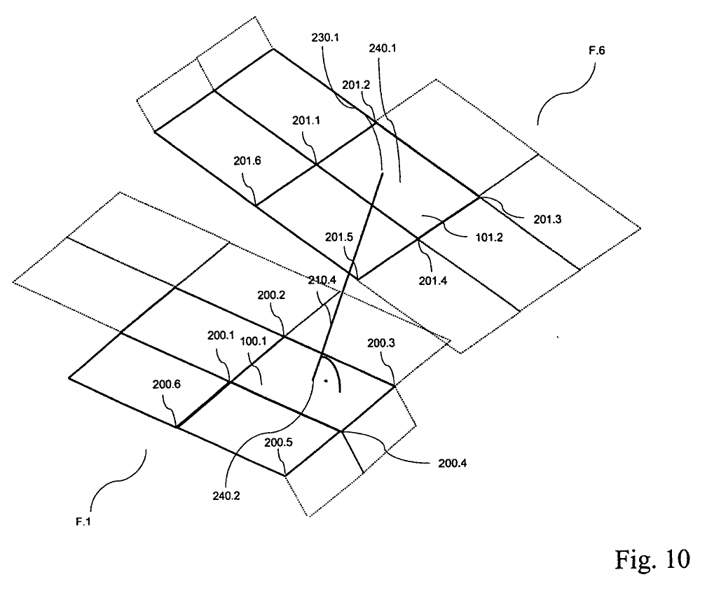

FIG. 10 shows the determination of the spacing between midpoint and point of intersection of a normal and the comparison with an edge length (modification of the fourth test);

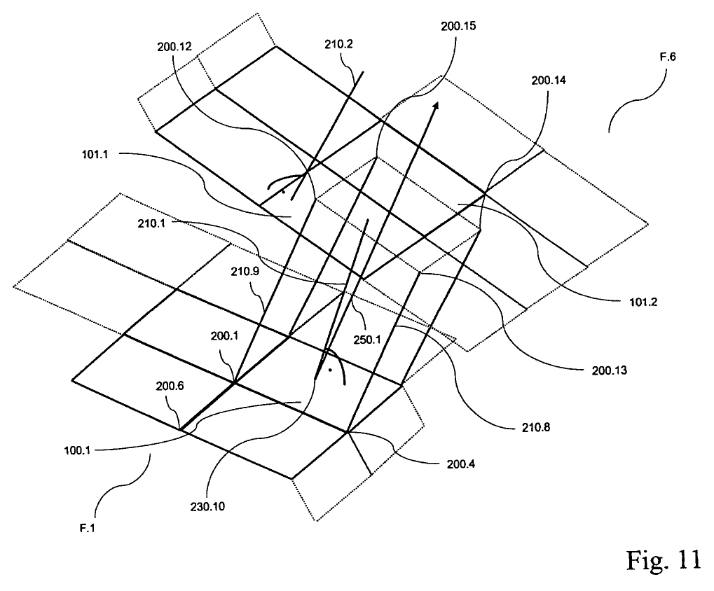

FIG. 11 shows the fifth test;

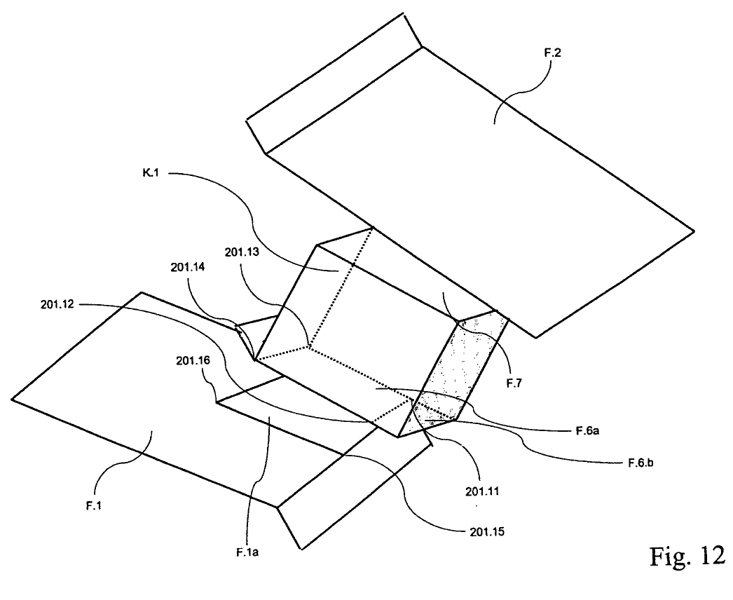

FIG. 12 shows connectable areas of the surfaces F.1 and F.2;

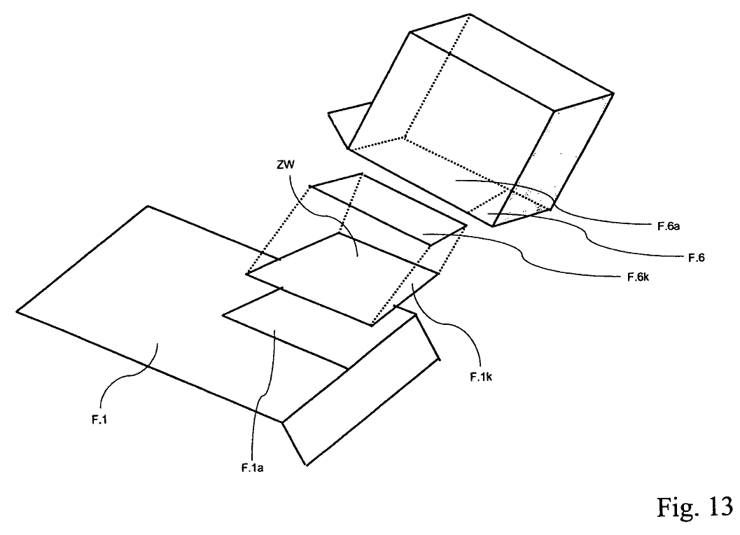

FIG. 13 shows an interspace that can be connected by a bonding layer;

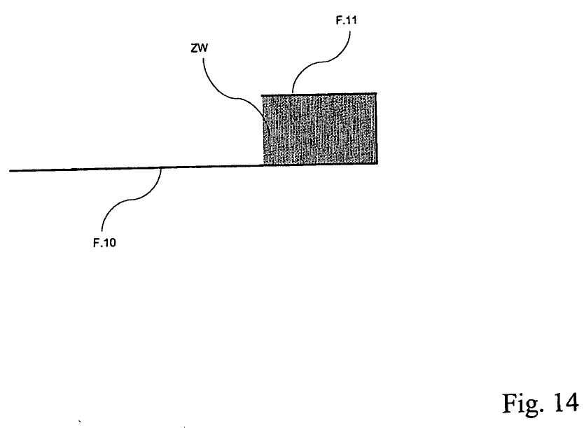

FIG. 14 shows an example of two connectable surfaces of the same body.

The embodiment described below relates to a bodywork of a motor vehicle as the system. The bodywork comprises various panels as well as other bodies, and it is automatically determined which of these panels are capable of being connected to one another in which areas by bonded joints.

A computerized design model of the bodywork was generated with the aid of a tool for computerized design (computer-aided design—CAD), and is available in the form of a CAD model. The CATIA CAD tool, for example, was used. A description of CATIA is available, for example at http://www.catia.com, requested on 2.5.2003. The entire bodywork including the panels is designed volumetrically such that the thicknesses of the panels are fixed.

Because the panels are very thin by comparison with their extent, they are approximated by their middle surfaces in the finite element simulations. All the middle surfaces are decomposed in the two-dimensional finite elements in the form of shell elements.

A preprocessor is used to generate the data required for a finite element simulation from the CAD model for the bodywork. The meshing of the CAD model of the bodywork is carried out automatically with the aid of this preprocessor. The method according to the invention which is described below is carried out during the meshing, specifically after the finite elements have been generated for the approximating panels.

An example of such a preprocessor is the MEDINA software tool. A description of MEDINA is available at http://www.c3pdm.com/des/products/medina/documentation/medina-DIN4 e.pdf, requested on 2.5.2003. The “MEDINA/PreProcessing” module automatically imports a CAD model that is stored in the data format of CATIA or else in the standardized STEP or VDA data formats. After the import MEDINA carries out the meshing of the CAD model of the bodywork automatically on the basis of stipulations by a user. In this process, the finite elements and the nodal points are generated in MEDINA, and these are stored in computerized form in the data format of MEDINA.

A tool for carrying out a simulation in accordance with the finite element method (FEM tool) imports this description in the data format of MEDINA or another data format, and carries out the finite element simulations. The person skilled in the art is familiar with various FEM tools, for example
MSC.NASTRAN and MSC.PATRAN, both described at http://www.mscsoftware.com/products/, requested on 2.5.2003,
ABAQUS, described at http://www.hks.com/products/products overview.html, requested on 2.5.2003,
PAMCRASH for finite element simulations of collisions, described at http://www.esi-group.com/products/crash/index.php, requested on 2.5.2003.

In this example, the design model of the system comprises two sheets and a volumetric body K.1. The sheets are both 2 mm thick in this example and are approximated in the respective middle by two surfaces F.1 and F.2. The body K.1 is represented by two boundary surfaces F.6 and F.7. FIG. 1 shows the body K.1 and four surfaces F.1, F.2 of the two sheets and F.6, F.7 of the body K.1. The surfaces F.1, F.6 and F.2 are folded and comprise two planes. The spacings and the different orientations of the surfaces and the body in space are represented with great exaggeration for the purposes of illustration. The surface F.6 of the body K.1 points toward the surface F.1 and is covered in FIG. 1.

All the pairs of surfaces that belong to two different bodies are determined. In all, there are 4 surfaces and therefore 4*3/2=6pairs, which consist in each case of two surfaces. Because the design model comprises a body with two surfaces, one of these six surface pairs consists of two surfaces of the same body, specifically the pair (F.6, F.7) The surface pair (F.6, F.7) is not investigated for connectability in this embodiment. The remaining five surface pairs are investigated.

A meshing of all the surfaces is generated. In this example, the finite elements all have the shape of triangular or quadrangular surface elements. All four nodal points of a quadrangular surface element lie in a plane in this example. Quadrangular surface elements to which this does not apply are preferably decomposed into two triangular surface elements for testing for connectability. An alternative to this provides that a quadrangular surface element whose nodal points do not lie in one plane be replaced for the testing of connectability by an approximating quadrangular surface element whose four nodal points all lie in a plane.

FIG. 2 shows a few surface elements for the bodies and for the middle surfaces of FIG. 1. The quadrangular surface elements preferably have the shape of rectangles, but other shapes are also possible. In this example the edge lengths of the surface elements are 10 mm and 5 mm.

The method according to the invention is explained by the example of the two middle surfaces F.1 and F.6, which approximate two different sheets. The pair of surfaces F.1, F.6 is automatically investigated as to which pairs of surface elements of the surfaces F.1., F.6 can be connected to one another by one bonded joint each. For this purpose, a decision is taken for each element pair as to whether the two surface elements of the element pair can be connected by a bonded joint or not.

FIG. 3 illustrates for example the selection of element pairs for the surface pair that consists of the two surfaces F.1 and F.6. The nodal points of all the surface elements are firstly determined, and their coordinates are stored in one vector each. In the case of five surface pairs, therefore, five vectors each having three coordinates of nodal points are stored. The nodal points 200.1, 200.2, 200.3, 200.4, 200.5 and 200.6 belong to the nodal points of the surface F.1. The nodal points 201.1, 201.2, 201.3, 201.4, 201.5 and 201.6 belong to the nodal points of the surface F.6.

It is prescribed in this example that a bonded joint may be 1 mm thick at most. An upper bound for the maximum spacing between the nodal points of two connectable surface elements is derived therefrom. This derivation is illustrated in FIG. 4.

It is assumed by way of simplification in the example of FIG. 4 that the two surface elements 100.2 and 101.2 are parallel to one another. The length of the path from the nodal point 201.1 of the surface F.6 to the nearest point 230.23 of the surface F.1 may be 1 mm at most. The nearest point 230.23 is the foot point of a normal to F.6 through the nodal point 201.1. The edge lengths of the two surface elements are 5 mm and 10 mm. The spacing 260.1 of the nodal point 201.1 from the nearest nodal point 200.7 is therefore smaller than or equal to

$$\sqrt{{a}^{2} + {b}^{2} + {c}^{2}} = \sqrt{{1}^{2} + {( 10 / 2 )}^{2} + {( 5 / 2 )}^{2}} = 5.67 mm .$$

In order to be on the safe side, Δ_{—}1=6 mm is fixed as upper bound Δ_{—}1 for the spacing between two nodal points.

The surface elements of the surface F.1 have a total of N_{—}1 nodal points, while those of the surface F.6 have a total of N_{—}2 nodal points. Each spacing between a nodal point of F.1 and a nodal point of F.6 is determined. This requires N_{—}1*N_{—}2 spacing calculations. The calculation of the spacing between two points requires much less computing time than other tests of finite elements, and so spacing calculations are firstly carried out, and as a function of the result of these spacing calculations, element pairs are selected and further tests, requiring more computational outlay, are carried out only for the selected element pairs. The calculated spacings are buffered in an N_{—}1*N_{—}2 matrix, because each spacing value is used repeatedly. In an alternative embodiment, a 1 or a 0 is stored in each of the N_{—}1*N_{—}2 fields of an N_{—}1*N_{—}2 matrix A. A(i,j) is equal to 1 when the spacing between the nodal point No. i of one surface and the nodal point No. j of the other surface is smaller than or equal to 6 mm, otherwise it is equal to 0.

In the example of FIG. 3, the following pairs of nodal points, inter alia, have a mutual spacing of at most Δ_{—}1=6 mm: 200.1 and 201.1, 200.1 and 201.2, 200.1 and 201.3, 200.1 and 201.4, 200.1 and 201.5, 200.1 and 201.6. 200.6 and 201.2, 200.5 and 201.3, for example, have a larger spacing.

Each element pair is determined whose one finite element has one nodal point of a selected node pair as a nodal point, and whose other finite element has the other nodal point of the same node pair as a nodal point. A selected node pair in FIG. 3 is the pair 200.1 and 201.1. Consequently, the following 4*4 element pairs are determined whose one finite element has the point 200.1, and whose other finite element has the point 201.1 as nodal points: 100.1 and 101.1, 100.1 and 101.2, 100.1 and 101.3, 100.1 and 101.4, 100.2 and 101.1, . . . , 100.4 and 101.1, 100.4 and 101.2, 100.4 and 101.3, 100.4 and 101.4.

A preselection is made from among these determined element pairs on the basis of the spacings between nodal points. One of the two following embodiments is applied for this purpose:

In one embodiment, it is tested for each determined element pair as to whether each nodal point of one finite element of the element pair has a spacing from at least one nodal point of the other finite element that is smaller than or equal to an upper bound Δ_{—}2, or not. The bound A_{—}2 is fixed such that in the example of FIG. 4, the element pair (100.2, 101.2) is preselected but the element pair (100.1, 101.2) is not. All three finite elements have edge lengths of 10 mm and 5 mm. As set forth above, however, each nodal point of 101.2 has a spacing from at least one nodal point of 100.2 that is smaller than 5.67 mm. Consequently, Δ_{—}2=6 mm is fixed as upper bound.

The surface element 100.1 has the nodal points 200.1, 200.2, 200.3 and 200.4. The surface element 101.2 has the nodal points 201.1, 201.2, 201.3 and 201.4. It is established by exercising read access to the N_{—}1*N_{—}2 matrix that the nodal point 200.1 of 100.1 has a spacing from the nodal point 201.2 of 101.2 of less than Δ_{—}2=6 mm. Furthermore, it is established that the spacings between 200.2 and 201.2, between 200.4 and 201.4 as well as between 200.3 and 201.3 are also less than Δ_{—}2=6 mm. Consequently, the element pair (100.1, 101.2) is preselected. By contrast, the spacings between the nodal point 201.3 of 101.2 and the nodal points 200.1, 200.4, 200.5 and 200.6 of 100.4 are all greater than Δ_{—}2=6 mm, for which reason the element pair (100.4, 101.2) is not preselected.

In the other embodiment, a test is made for each determined element pair as to whether each nodal point of one finite element of the element pair has a spacing from each nodal point of the other finite element that is smaller than or equal to an upper bound Δ_{—}2, or not. The bound Δ_{—}2 is fixed such that, in the example of FIG. 4 the element pair (100.2, 101.2) is preselected, but the element pair (100.1, 101.2) is not. All three finite elements have edge lengths of 10 mm and 5 mm. The spacing between a nodal point of 100.2 and 101.2 is at most

$$\sqrt{{a}^{2} + {b}^{2} + {c}^{2}} = \sqrt{{1}^{2} + {10}^{2} + {5}^{2}} = 11.22 mm .$$

By contrast, the spacing between 201.1 and 200.3 is more than 12 mm. Consequently, Δ_{—}2=12 mm is fixed in this embodiment.

In this embodiment, the preselection is undertaken as follows: the surface element 100.1 has the nodal points 200.1, 200.2, 200.3 and 200.4. The surface element 101.2 has the nodal points 201.1, 201.2, 201.3 and 201.4. By exercising read access to the N_{—}1*N_{—}2 matrix, it is established that the nodal point 200.1 of 100.1 has a spacing of 10 mm or less in each case from 201.1, 201.2, 201.3 and 201.4. Furthermore, it is established that the spacing between 200.2 and 201.1, between 200.2 and 201.2, between 200.2 and 201.3 as well as between 200.2 and 201.4 is less than Δ_{—}2=12 mm in each case, that the spacing between 200.3 and 201.1, between 200.3 and 201.2, between 200.3 and 201.3 as well as between 200.3 and 201.4 is less than Δ_{—}2=12 mm in each case and that the spacing between 200.4 and 201.1, between 200.4 and 201.2, between 200.4 and 201.3, as well as between 200.4 and 201.4 is less than Δ_{—}2=12 mm in each case. Consequently, the element pair (100.1, 101.2) is preselected. By contrast, the nodal point 201.2 of 101.2 has a spacing of greater than Δ_{—}2 from the nodal point 200.5 of 100.4. Consequently, the element pair (100.4, 101.2) is not preselected.

This procedure is carried out for all the determined element pairs. The element pairs are selected thereby. The further tests are carried out only for these selected element pairs.

The spacing between the two surface elements 100.1 and 101.2 is determined by the first test, which FIG. 5 illustrates. For the test, a normal to the surface element 100.1 is determined and a further normal to the surface element 101.2 is determined. A straight line 211.4 is generated through the midpoint 240.2 of 100.1. The midpoint 240.2 is determined as the point of intersection of the two diagonals in the surface element 100.1. The straight line 211.4 has the same direction as the sum of the two normals to 100.1 and 101.2, respectively. The point of intersection 230.1 between the straight line 211.4 and the surface element 101.2 is determined. If there is no such point of intersection, the test delivers a negative result. Otherwise, the spacing between the midpoint 240.2 and the point of intersection 230.1 is compared with a prescribed upper bound Δ_{—}5=1.88 mm. In addition, the spacing is preferably compared with a lower bound Δ_{—}6=0.8 mm. If this spacing is smaller than or equal to Δ_{—}5 and greater than or equal to Δ_{—}6, the test delivers a positive result. Otherwise, it is decided automatically that 100.1 and 101.2 cannot be connected by a bonded joint.

A modification (not illustrated by a figure) of the first test makes provision to determine the two midpoints of the two surface elements 100.1 and 101.2. The spacing between the two midpoints is determined and used as the spacing between the two surface elements.

FIG. 6 illustrates a second test for the element pair with the surface elements 100.4 and 101.1. One normal each is generated to 100.1 at the four nodal points 200.1, 200.4, 200.5 and 200.6 of the surface element 100.4. The four points of intersection of these four normals with the surface F.6 are determined. Such a point of intersection can also lie outside the surface element 101.1. The normal 210.5 through the nodal point 200.4 and its point of intersection 230.4 with the surface F.6 are represented in FIG. 6. 230.4 lies outside the surface element 101.1. The spacing between the nodal point 200.4 and the point of intersection 230.4 of the normals 210.5 running through 200.3 is determined and compared with an upper bound Δ_{—}7 and a lower bound Δ_{—}8. Furthermore,
the spacing between 200.1 and the point of intersection of the normal running through 200.1 with F.6,
the spacing between 200.5 and the point of intersection of the normal running through 200.5 with F.6,
and the spacing between 200.6 and the point of intersection of the normal running through 200.6 with F.6
   are determined and compared in each case with Δ_{—}7 and Δ_{—}8. Furthermore, four normals that run through 201.1, 201.4, 201.5 and 201.6 are generated to 101.1. Their points of intersection with F.1 are determined. The normal 210.6 through the nodal point 201.1 and its point of intersection 230.5 with the surface F.1 are shown in FIG. 6. The four spacings of the four points of intersection of the four normals to F.6 with the respective nodal points through 201.1, 201.4, 201.5 and 201.6 are determined and compared in each case with Δ_{—}7 and Δ_{—}8.

FIG. 7 illustrates the third test, carried out next, by means of which the angle 220.1 between the two surface elements 100.1 and 101.2 is determined. A normal 210.1 to the surface element 100.1, which intersects 100.1 at a foot point 230.10, is generated. In the case of flat surface elements, the result of the test is independent of the selection of the foot point 230.10. If a surface element with four nodal points is not flat, it is decomposed into two triangular surface elements, and the following method is executed for each of these two triangles. The normal is preferably of length 1. Furthermore, there is generated to the surface element 101.2 a normal 210.2 that is likewise of length 1. This normal is displaced to the foot point 230.10. The position of this displaced normals is illustrated by the dashed line 210.3. The angle α between 210.1 and 210.2, which is equal to the angle 220.1 between 210.1 and 210.3, is determined in accordance with the following relationship:
210.1*210.2=∥210.1∥*μ210.2∥*cos α=cos α=cos(220.1)

Here, 210.1*210.2 denotes the scalar product of the two vectors 210.1 and 210.2, and ∥112 10.1∥denotes the Euclidean length of the vector 210.1. The angle α determined in such a way is compared with a prescribed upper bound Δ_{—}4=10 degrees. The test delivers a positive result if the angle 220.1 is smaller than or equal to Δ_{—}4. Otherwise, it is decided automatically that 100.1 and 101.2 cannot be connected by a bonded joint.

A modification of the third test just described is illustrated in FIG. 8. The midpoint 240.2 of the surface element 100.1 is determined. A normal 210.4 to the surface element 100.1, which intersects 100.1 at the midpoint 240.2, is generated. The point of intersection 230.1 of the normals 210.4 with the other surface element 101.2 is determined. If there is no such point of intersection, the test delivers a negative result and it is decided that 100.1 and 101.2 cannot be connected by a bonded joint. If there is a point of intersection 230.1, a normal 210.5 through the point of intersection 230.1 is generated on the other surface element 101.2. The angle 220.2 between 210.4 and 210.5 is compared with the prescribed upper bound Δ_{—}4. The test delivers a positive result if the angle 220.2 is smaller than or equal to Δ_{—}4. Otherwise it is decided automatically that 100.1 and 101.2 cannot be connected by a bonded joint.

The fourth test is illustrated in FIG. 9. The midpoint 240.2 of 100.1 is determined or reused from a prior test. A normal 210.4 to 100.1 is generated through the midpoint 240.2. The point of intersection 230.1 of this normals with the surface element 101.2 is determined. The test delivers a negative result if there is no such point of intersection. Otherwise, the midpoint 240.1 of the surface element 101.2 and the spacing between 230.1 and 240.1 are determined. This spacing is compared with a prescribed upper bound Δ_{—}9=4 mm. The test delivers a positive result if this spacing is smaller than or equal to Δ_{—}9. Otherwise it is decided automatically that 100.1 and 101.2 cannot be connected by a bonded joint.

A modification of this fourth test is illustrated by FIG. 10. As already described, the spacing between the point of intersection 230.1 and the midpoint 240.1 of 101.2 is determined. In addition, the length of the longest edge of the two surface elements 100.1 and 101.2 is determined. The length of eight edges, specifically if the following edges, is determined for this purpose:
the edge from 200.1 to 200.2,
the edge from 200.1 to 200.4,
the edge from 200.3 to 200.2,
the edge from 200.3 to 200.4,
the edge from 201.1 to 201.2,
the edge from 201.1 to 201.4,
the edge from 201.3 to 201.2,
the edge from 201.3 to 201.4.

In this case, the edge from 200.1 to 200.4 and the edge from 200.3 to 200.2 are the longest edges of 100.1 and are of equal length. The quotient of the spacing between the point of intersection 230.1 and the midpoint 240.1 (in the numerator) and the length of the edge from 200.1 to 200.4 (in the denominator) is calculated. The numerator can vanish, while the denominator cannot. This spacing is compared with a prescribed upper bound Δ_{—}10=0.9 mm. The test delivers a positive result if this spacing is smaller than or equal to Δ_{—}10. Otherwise it is decided automatically that 100.1 and 101.2 cannot be connected by a bonded joint.

The fifth test is illustrated by FIG. 11. Two normals 210.1 to the surface element 100.1 and 210.2 to the surface element 101.2 are formed. The two foot points of the normals can be selected as desired. Two normal vectors of equal length are generated on these two normals. These two normal vectors are not shown in FIG. 11. The sum vector 250.1 of these two normal vectors is generated. It begins at the foot point 230.10 of the normals 210.1. In this example, a straight line 210.8 that runs through the nodal point 200.4 of one surface element 100.1 and has the direction of the sum vector 250.1 is firstly generated. This straight line 210.8 intersects the surface F.6 at the point 200.13. In the same way a straight line 210.9 that goes through the nodal point 200.1 is generated in the direction of 250.1. This straight line 210.9 intersects F.6 at 200.12. The same procedure is carried out for the two other nodal points of 100.1. A quadrangle with the corners 200.12, 200.13, 200.14 and 200.15 is thereby generated. A test is made as to whether this quadrangle has an overlap area with the surface element 101.2 or not. If an overlap area is present, it is established that the fifth test delivers a positive result. An overlap area is present in the example of FIG. 11.

The following tests are preferably carried out for a determined element pair:
the modification of the first test (spacing of the midpoints)
the third test, if said first test has returned a positive result,
the modification of the fourth test, if said third test has returned a positive result,
the fifth test, if said fourth test has returned a positive result,
if said fifth test has also returned a positive result, it is decided that the two surface elements of the element pair are connectable to one another.

The following decisions are taken in the example of FIG. 3 to FIG. 11:
100.1 is connectable to 101.2,
100.2 is connectable to 101.3,
100.3 is connectable to 101.4,
100.4 is connectable to 101.1.

FIG. 12 illustrates which areas of the surfaces shown in FIG. 1 are connectable to one another. These areas are automatically determined by the method described above. It is determined which surface elements of F.1 are connectable to in each case one surface element of F.6. The set of these surface elements of F.1 delivers the sub-area of F.1 connectable to F.6. The corresponding steps are carried out for F.6. One sub-area F.1a of the surface F.1 and two sub-areas F.6a and F.6b of the surface F.6 are shown in FIG. 12. F.1a has the two corner points 201.15 and 201.16 as well as two further corner points (not shown). F.6a has the four corner points 201.11, 201.12, 201.13 and 201.14. The method according to the invention delivers, inter alia the result that the two sub-areas F.1a and F.6a are connectable to one another. The sub-area F.6b is not connectable to a sub-area of F.1.

The two sub-areas F.1a and F.6a of the surfaces F.1 and F.6, which are connectable to one another are shown in FIG. 13. The thicknesses of all the sheets of the system are prescribed by the computerized design model. Consequently, the two thicknesses d_{—1} and d_{—3} are prescribed for those two sheets that are approximated by the surfaces F.1 and F.6. Two surfaces F.1k and F.6k are generated. F.1k lies in the top surface of that sheet which is approximated by the surface F.1, and therefore also in the boundary surface of the connecting bonding layer. F.6k is congruent to F.6a, but belongs to the bonding layer. F.1k and F.6k have the same dimensions and orientations as F.1a and F.6a, respectively. F.1k lies parallel to F.1a and F.6k lies parallel to F.6a. The spacing between F.1a and F.1k is 0.5*d_1 (that is to say half the thickness of the sheet). FIG. 13 shows the two sub-areas F.1k and F.6k, and also the interspace ZW between these two sub-areas.

In this embodiment, the two surfaces of a surface pair always belong to two different bodies of the system. However, it is also possible to investigate two surfaces of the same body for connectability. FIG. 14 shows an example for two connectable surfaces F.10 and F.11 of the same body. According to the invention, it is determined that a bonded joint can be generated that fills up the interspace.

In the next step, the interspaces between the connectable sub-areas are preferably automatically meshed. The thickness of the sheet is taken into account thereby, and only interspaces in layers between sheets are meshed. The meshing of an interspace that connects two sheets of the system is executed automatically. The following information is taken over in this case from the computerized design model of the system:
the spatial position of the two approximating surfaces F.1 and F.6, and
the thicknesses of the two sheets—in this example, each sheet has a thickness that is constant over the entire extent, and the two thicknesses can differ from one another.

In this example, the thickness of the interspace ZW is 0.8 mm. The thickness and the spatial extent of the interspace are obtained automatically from this geometric information about the sheets. Instead of this, it is also possible to prescribe the thickness of the interspace and the spatial position of the two approximating surfaces.

It is possible to decompose the interspaces in the transverse direction into a number of volume elements. If, for example, an interspace is 0.8 mm thick and it is provided that an interspace in the transverse direction is to be decomposed into two volume elements, volume elements are generated that each have an edge length of 0.4 mm in the transverse direction of the interspace, that is to say perpendicular to the boundary surfaces of the layer. The meshing of the interspaces is controlled by a few parameters, which are clear. These parameters can be selected such that the meshing delivers the best results for the respective formulation of the object. The volume elements are preferably cuboid, but hexahedrons or other shapes of volume elements are also possible.

The following prescribed parameters continue to be used for the meshing:
a lower and/or upper bound for the edge length of a volume element in each longitudinal direction of an interspace,
the shape of the volume elements, and
a meshing method, for example paving or free meshing.

Instead of prescribing an edge length in the longitudinal direction, it is also possible to prescribe the number of the volume elements into which the interspace is to be decomposed in the transverse direction.

All the volume elements preferably have the shape of cuboids or at least of hexahedrons. The number of the volume elements in the transverse direction is 2 in this example. Thus, in the transverse direction two juxtaposed volume elements are to be generated in each case. It is standard for the two volume elements to have the same edge length in the transverse direction, and so all the edges in the transverse direction have a length of 0.8 mm: 2=0.4 mm. Also provided in this example is an edge length in the longitudinal direction of 5 mm in flat areas of the interspace, and 4 mm in curved areas.

As an alternative to this, it is not the edge length in the longitudinal direction that is prescribed, but a lower and/or upper bound for the ratio of longest to shortest edge of a volume element. For example, a ratio of 10 is prescribed in curved areas of an interspace, and a ratio of 12.5 is prescribed in flat areas. As already explained, the shortest edge length is 0.4 mm. 0.4 mm*12.5=5 mm and 0.4 mm*10=4 mm are derived automatically therefrom as length of the remaining edges of a volume element in curved and flat areas of the layer, respectively.

After conclusion of the meshing of the computerized design model, the physical relationships and boundary conditions are supplemented. This step is undertaken, for example with the aid of “MEDINA/PostProcessing”.

An example of such a relationship describes the stress in a finite element as a function of the displacement of its nodal points. An expansion tensor ε of the finite element is determined as a function of the displacement of the nodal points. A compliance matrix D is prescribed. The relationship σ=D*ε exists between the stress tensor σ of the finite element and the expansion tensor ε.

It is possible that the deformations result from a temperature variation ΔT. Let α be the expansion coefficient of the material used for producing the respective body. Then the relationship σ=D*(ε−α*ΔT) exists.

Furthermore, the relationship between the acting force F and deformation U is determined. A compliance matrix K of the body is derived from properties of the materials that are used for producing the respective body, for example elastic modulus and Poisson ratio, and from the geometry of the body. The relationship U=K*F exists between the deformation and the acting force. It is possible that some components of U are known, for example must vanish, and some components of F are known and others unknown.

The interspaces are preferably meshed, after determination of the connectable sub-areas and of the interspaces between these. However, the meshing is not necessarily executed. For example, it is also possible that instead of this the interspaces are highlighted in the design model. An operative can decide whether precisely these interspaces are actually to become a component of a bonded joint, or to be filled up with sealing material and can supplement further connectable sub-areas if required, or mark sub-areas detected as connectable as not connectable.

It is also possible that the total volume of the interspaces is determined automatically and that it is derived therefrom how much material, for example adhesive or sealing material is to be filled overall into these interspaces. If a sheet is approximated by one surface, the thickness of this sheet is taken into account so that only the volume of the interspace between this sheet is taken into account but not the volume of the sheet itself.

After the meshing of the boundary surface F.6 of the body K.1, of the middle surface F.1 of the sheet, and of connecting the bonded joint K.1 are concluded, and the system of equations has been generated, the system of equations is solved with the aid of a commercial software tool for the finite element method (FEM tool).

The person skilled in the art is familiar with various FEM tools, for example,
MSC.NASTRAN and MSC.PATRAN, both described at http://www.mscsoftware.com/products/, requested on Feb. 5, 2003
ABAQUS, described at http://www.hks.com/products/products overview.html, requested on Feb. 5, 2003,
PAMCRASH for finite element simulations of collisions, described at http://www.esi-group.com/products/crash/index.php, requested on Feb. 5, 2003.

The solution delivers for each nodal point of the design model the value that is adopted by the physical quantity at this nodal point. The values of the physical quantity at the determined closest points are calculated by substitution in the function. The solution is evaluated in order to analyze the design model of the system.

### LIST OF REFERENCE SYMBOLS

| Symbols | Meaning |
|---|---|
| F.1., F.2 | Approximating surfaces |
| F.1a | Connectable sub-area of F.1 |
| F.1k, F.6k | Boundary surfaces of the connecting layer in the |
| | interspace ZW |
| F.6, F.7 | Two boundary surfaces of the body K.1 |
| F.6a | Connectable sub-area of F.6 |
| F.6b | Unconnectable sub-area of F.6 |
| K.1 | Body |
| ZW | Interspace between F.1a and F.6a, that is filled up by a |
| | connecting layer |
| 100.1, 100.2, . . . | Finite elements of the surface F.1 |
| 101.1, 101.2, . . . | Finite elements of the surface F.6 |
| 200.1, 200.2, . . . | Nodal points of finite elements of the surface F.1 |
| 201.1, 201.2, . . . | Nodal points of finite elements of the surface F.6 |
| 210.1, 210.2, . . . | Normals to finite elements |
| 211.4 | Straight line in the direction of the sum vector from |
| | two normals |
| 220.1, 220.2 | Angle between two normals |
| 230.1, 230.2 | Points of intersection of straight lines with finite |
| | elements |
| 240.1, 240.2 | Midpoints of finite elements |
| 250.1 | Sum vector |
| 260.1 | Spacing between two nodal points |

1-20. (canceled)

21. A method for automatically detecting connectable surfaces in a technical system, the system including a plurality of bodies, a joining technology being prescribed, the joining technology capable of being applied to produce a layer between in each case two bodies of the system, and a computerized design model of the system being given that, for each body of the system, includes at least one surface belonging to the body, the method having the steps of:
producing finite elements for the surfaces,
selecting for each surface pair that includes two different surfaces of the design model all the element pairs that in each case one finite element of one surface, and of one finite element of the other surface of the surface pair, and whose spacing from one another is smaller than or equal to a prescribed upper bound,
deciding for each selected element pair whether the two finite elements of the element pair can be connected by the joining technology, the deciding including applying a computer-evaluable decision criterion that compares at least one of the spacings, positions and orientations of the two finite elements with prescribed bounds.

22. The method as recited in claim 21 wherein the selecting step includes that when selecting the element pairs of a surface pair
all the nodal points of the finite elements of the two surfaces are determined,
all the node pairs that consist in each case of one nodal point of one surface and one nodal point of the other surface are determined,
the spacing between the two nodal points of the node pair is calculated for each node pair,
those node pairs are selected whose nodal points have a spacing that is smaller than or equal to the bound, and
each element pair is determined whose one finite element has one nodal point of a selected node pair as a nodal point, and whose other finite element has the other nodal point of the same node pair as a nodal point, and
determined element pairs are used as selected element pairs.

23. The method as recited in claim 22 wherein
each determined element pair is preselected whenever each nodal point of one finite element of the element pair has a spacing from at least one nodal point of the other finite element that is smaller than or equal to the prescribed upper bound,
each preselected element pair is selected whenever the spacing between the two finite elements of the element pair is smaller than or equal to the upper bound,
and a decision is made for each non-preselected element pair that the two finite elements of the element pair are not connectable.

24. The method as recited in claim 22 wherein
each determined element pair is preselected whenever each nodal point of one finite element of the element pair has a spacing from all nodal points of the other finite element that is smaller than or equal to the prescribed upper bound,
each preselected element pair is selected whenever the spacing between the two finite elements of the element pair is smaller than or equal to the upper bound,
and a decision is made for each non-preselected element pair that the two finite elements of the element pair are not connectable.

25. The method as recited in claim 21 wherein the selecting step includes that whenever the spacing between the two finite elements of the element pair is greater than a prescribed bound the element pair is not selected.

26. The method as recited in claim 21 wherein the deciding step includes comparing the spacing between the two finite elements of the element pair, and when comparing the spacing of the two finite elements of the element pair with a prescribed upper and/or lower bound at least one of the following sequences is carried out:
determining the point of intersection of the two diagonals of one finite element, determining the point of intersection of the two diagonals of the other finite element, determining the spacing between the two points of intersection,
erecting a normal to one finite element of the element pair, determining the foot point of the normal in the finite element, determining the point of intersection of the normal with the other finite element, comparing the spacing between foot point and point of intersection with a prescribed upper and/or lower bound,
erecting a normal to one finite element and a normal to the other finite element of the element pair, determining the sum vector of the two normals, determining the point of intersection of a straight line in the direction of the sum vector with the other finite element, calculating the spacing between point of intersection of the straight line with one finite element and point of intersection of the straight line with the other finite element, comparing the spacing with a prescribed upper and/or lower bound,
for each nodal point of one finite element of the pair, erecting a normal through the nodal point on the finite element, determining the point of intersection of the normal with the other finite element, comparing the spacing between nodal point and point of intersection with a prescribed upper and/or lower bound.

27. The method as recited in claim 21 wherein when taking a decision for the selected element pair at least one of the following tests is carried out:
testing if the finite elements of the element pair belong to surfaces of different bodies,
determining the angle between the two finite elements of the element pair and comparing the angle with a prescribed upper bound,
projecting one finite element of the element pair along a projection vector and testing whether the projected finite element overlaps with the other finite element or not,
determining the midpoints of the two finite elements of the element pair, projecting one finite element along a projection vector, determining the spacing between the midpoint of the projected finite element and the midpoint of the other finite element, comparing the spacing with the prescribed upper bound,
determining the midpoints of the two finite elements of the element pair, projecting one finite element along a projection vector, determining the spacing between the midpoint of the projected finite element and the midpoint of the other finite element, determining the length of the longest edge of the two finite elements of the pair, comparing the quotient of spacing and longest edge length with the prescribed upper bound.

28. The method as recited in claim 27 wherein
the projection vector is generated as sum vector from a normal to one finite element, and a normal of equal length to the other finite element,
and the angle between the two finite elements is generated as angle between a normal to one finite element and a normal to the other finite element.

29. The method as recited in claim 21 wherein the prescribed bounds depend on at least one of the following parameters:
a technical parameter of the prescribed joining technology,
the nature of a surface of one of the bodies,
a technical parameter of a material provided for producing one of the bodies, and
a stipulation valid for all the bodies of the system.

30. The method as recited in claim 21 wherein the prescribed joining technology includes one of the following methods:
layer joining, and
inserting a spacing layer joining.

31. The method as recited in claim 21 wherein various possible joining technologies are prescribed, and for each possible joining technology,
a decision criterion is prescribed that compares the positions and/or orientations of two finite elements with prescribed bounds dependent on the joining technology,
and an evaluation of the joining technology are prescribed,
the pairs of finite elements connectable by the joining technology are determined for each joining technology,
the decision criterion prescribed for the joining technology being applied to the finite elements of the pair during the determination,
an evaluation of the joining technology with reference to the system is determined by applying an evaluation function calculated from the prescribed evaluation of the joining technology and the element pairs connectable with the aid of the joining technology,
that a specific joining technology is selected for which the highest evaluation was determined with reference to the system, and
the further finite elements are generated in the interspaces that are delimited by those element pairs connectable with the aid of the selected specific joining technology.

32. The method as recited in claim 21 further comprising automatically generating further finite elements in the interspaces delimited by the finite elements detected as being connectable.

33. The method as recited in claim 32 wherein the further finite elements are volume elements in the interspaces, the volume elements being generated in such a way that all the interspaces are fully meshed by volume elements, and the meshing is produced by using geometric information relating to the interspaces and stipulations for the meshing.

34. The method as recited in claim 32 wherein at least one further finite element in an interspace is a planar element perpendicular to an adjoining surface of the design model.

35. The method as recited in claim 32 further comprising setting up, in accordance with the finite element method, a system of equations with unknowns being values assumed by a spatially variable physical quantity at the nodal points of the generated finite elements, and the values of the quantity at the nodal points are determined by a numerical solution of the system of equations.

36. The method as recited in claim 35 wherein for a set of nodal points of further finite elements in the interspaces,
there are respectively determined a closest surface of the design model, a closest finite element of this surface, and a closest point on this finite element,
and equations for physical relationships between
the values that the physical quantity assumes in the set of nodal points,
and the values that the physical quantity at the closest points, determined for the set, of the surfaces
are generated and used when setting up the system of equations.

37. The method as recited in claim 35 wherein for at least one nodal point of the set,
a function is generated for a physical relationship between the value that the physical quantity assumes at the closest point and the values that this quantity assumes at the nodal points of the closest finite element,
and the value of the physical quantity at the determined point is eliminated by using the function when setting up the system of equations.

38. The method as recited in claim 21 further comprising determining a total volume in interspaces between all the connectable element pairs.

39. A computer program product loadable directly into an internal memory of a computer and comprising sections of software capable of executing on the computer the method as recited in claim 21.

40. A computer program product stored on a computer readable medium and comprising a computer readable program prompting a computer to execute the method as recited in claim 21.
